(19) United States
(12) Patent Application Publication
(10) Pub. No.: US 2016/0321752 A1
(43) Pub. Date: Nov. 3, 2016

(54) Digitally Encrypted Securities Platform, Along With Methods And Systems For The Same

(71) Applicant: Medici, Inc., Salt Lake City, UT (US)

(72) Inventors: John Tabacco, Jersey City, NJ (US); Alec Wilkins, Salt Lake City, UT (US); John Welborn, Salt Lake City, UT (US)

(21) Appl. No.: 15/141,582

(22) Filed: Apr. 28, 2016

Related U.S. Application Data
(60) Provisional application No. 62/246,713, filed on Oct. 27, 2015.
(60) Provisional application No. 62/156,027, filed on May 1, 2015.

(51) Int. Cl. G06Q 40/04; G06Q 20/36

(52) U.S. Cl. CPC G06Q 40/04; G06Q 20/3674; G06Q 2220/00

(57) ABSTRACT

Various embodiments of the present technology relate to methods and systems for securely transferring securities and for preventing naked short selling of securities. In some implementations, the system receives inventory securities available for pre-borrowing and authorizes placement of a right to pre-borrow the one or more securities at an auction administered by an alternative trading system. The securities that are auctioned to a bidder are then received into a first addressed account associated with the token generator. In response to receiving the securities into the first addressed account, the system generates a token indicating one or more borrowing parameters. Upon receiving notification from the alternative trading system that the token is matched with a bid, the system cryptographically signs a transaction to transfer the token to a second addressed account associated with the bidder. Thereafter, if the bidder so chooses, the token can be sold to other customers.

### CROSS-REFERENCE TO RELATED APPLICATIONS

This application claims the benefit of U.S. Provisional Application No. 62/156,027, filed on May 1, 2015, entitled “DIGITALLY ENCRYPTED CUSTODIAL REGISTRY FOR SECURITIES LENDING, BORROWING AND TRADING USING A DISTRIBUTED LEDGER,” and U.S. Provisional Application No. 62/246,713, filed on Oct. 27, 2015, entitled “DIGITALLY ENCRYPTED CUSTODIAL REGISTRY FOR SECURITIES LENDING, BORROWING AND TRADING USING A DISTRIBUTED LEDGER,” both of which are hereby incorporated by reference for all purposes in their entireties.

### TECHNICAL FIELD

Various embodiments of the present disclosure generally relate to securities. More specifically, various embodiments of the present disclosure relate to a digitally encrypted custodial registry for securities lending, borrowing and trading using a distributed ledger.

### BACKGROUND

A short sale is the sale of a security that is not owned by the trader but that is promised to be delivered. Before shorting certain securities, the trader must borrow a security or determine that it can be borrowed. For example, brokerage firms can lend the trader shares from the brokerage's own inventory, from another one of the firm's customers, or from another brokerage firm. After the shares are sold, the proceeds are credited to the trader's account. At some time in the future, the trader must “close” the short by buying back the same number of shares and returning them to the lender. By shorting a security, the trader is betting that the price of the security will drop, allowing the trader to buy back the security at the lower price and make a profit on the difference. However, if the trader bets wrong and the price of the security rises, the trader has to buy the security back at the higher price as well as incur costs to borrow the securities needed for settlement until closing the position, causing the trader to lose money.

As discussed above, prior to shorting a security, a trader, for certain hard-to-borrow securities, must borrow the security or determine that the shares can be borrowed. However, due to loopholes in rules and discrepancies between paper and electronic trading systems, some traders illegally sell shares that have not been affirmatively determined to exist, which is a practice called “naked short selling.”

Due to limitations in the current system, Continuous Net Settlement (“CNS”), a trader who has properly located shares to sell can still be at risk of being a naked short seller. Within CNS, the National Securities Clearing Corporation (“NSCC”) acts as the central counterparty for clearance and settlement for virtually all broker-to-broker equity, corporate and municipal bond and unit investment trust trading in the United States. CNS settles trades from the nation's major exchanges, markets and other sources and nets these transactions to one security position per member per day. To do this, CNS includes an automated book-entry accounting system that centralizes settlement and maintains an orderly flow of security and money balances.

CNS operates as a First In First Out (“FIFO”) system, leaving a short seller vulnerable to accusations of being a naked short seller. For example, suppose a naked short seller has failed to deliver the shares three days after settlement. Further suppose a second short seller made the proper arrangements to deliver his or her shares on his or her day of settlement. The second short seller's day of settlement is three days earlier than the naked short seller's day of settlement. Under the current FIFO regime, CNS would credit the naked short seller with the second short seller's shares, leaving the second short seller at risk of being a naked short seller through no fault of his own. Because there is no audit trail, the CNS cannot specifically identify which borrowed shares should be credited to which account. Therefore, the account with the most risk (i.e., the first naked short seller's account) is credited with the shares.

Another limitation with legacy systems is that the right to sell the shares is not liquid. That is, because the borrowed shares are not recorded as borrowed, the trader cannot re-sell his or her right to sell the shares.

### BRIEF DESCRIPTION OF THE DRAWINGS

Embodiments of the present disclosure will be described and explained through the use of the accompanying drawings in which:

FIG. 1 illustrates an example of a network-based deployment environment in accordance with various embodiments of the disclosure;

FIG. 2 illustrates a set of components in a Crypto Securities Platform in accordance with one or more embodiments of the present disclosure;

FIG. 3 is a diagram presenting an overview of a create-to-lend process for ETF short selling in accordance with one or more embodiments of the present disclosure;

FIG. 4 is a diagram illustrating interaction of components used in pricing the lending and borrowing of shares for a short sale, and recording the lending and borrowing of shares for the short sale in a digital registry in accordance with various embodiments of the disclosure;

FIG. 5 is a flow chart of a short token process from the perspective of a Crypto Securities Platform in accordance with various embodiments of the disclosure;

FIG. 6 is a flow chart of a short token process from the perspective of an alternative trading system in accordance with various embodiments of the disclosure;

FIGS. 7-8 illustrate a short token flow process for the Crypto Securities Platform in accordance with various embodiments of the disclosure;

FIG. 9 is a flowchart of a short token process from the perspective of a Crypto Securities Platform in accordance with one or more embodiments of the present disclosure;

FIG. 10 is a flowchart of a short token process from the perspective of an alternative trading system in accordance with one or more embodiments of the present disclosure; and

FIG. 11 illustrates an example of a computer system with which one or more embodiments of the present disclosure may be utilized.

### DETAILED DESCRIPTION

Various embodiments of the present disclosure generally relate to securities. More specifically, various embodiments of the present disclosure relate to a digitally encrypted securities platform, and, even more particularly, to a digitally encrypted cryptographic custodial registry for securities lending, borrowing and trading using a distributed ledger, such as Crypto Securities Platform. Crypto Securities Platform creates a cryptographic registry of ownership of securities, allowing securities owners to have a redundant method of proving ownership. Additionally, this cryptographic registry allows securities owners to lend securities to traders for the settlement of short sale transactions using distributed and cryptographic techniques. The cryptographic registry also allows for liquidity in the borrowed shares.

Currently, securities ownership is recorded at custodian banks, brokerage firms, or other entities in databases on one or more servers. The Crypto Securities Platform can record securities ownership, including any ownership changes, on a distributed ledger using cryptography. Creating a digital record of securities has many benefits. For example, the digital record can be used as a redundant record of the paper or other non-encrypted records of ownership should the brokerage firm or custodian bank have an issue accessing ownership on the traditional systems. Additionally, the digital record of securities can be used to identify securities that are available for loan to support short selling of securities.

In this application, “securities” refers to financing or investment instruments issued by an entity or government agency that denotes an ownership interest and provides evidence of a debt, a right to share in the earnings of the issuer, or a right in the distribution of a property. Examples of securities include bonds, debentures, notes, options, shares, warrants, and exchange traded funds (“ETF”). Securities may also include digital securities and digital interests in securities. The disclosure discusses preventing naked short sales for securities; however, the concepts disclosed herein can be applied to commodities and currencies (e.g., cash, cash equivalents such as crypto currencies).

To overcome the limitations of legacy systems, the Crypto Securities Platform provides a registry that records ownership and pricing, including the ownership and pricing of the right to borrow the shares, which allows traders to prove that the trader properly located shares prior to shorting and disallows others to use the allocated shares to satisfy their trades.

The Crypto Securities Platform eliminates the trader's risk of being accused of being a naked short seller on settlement day because the trader can prove via the distributed ledger that the trader achieved authorization from the holder of the shares. To accomplish this, the Crypto Securities Platform receives an indication from a financial institution holding the shares which shares are available for pre-borrowing. The Crypto Securities Platform holds an auction on an alternative trading system (“ATS”) and receives bids to pre-borrow the shares. In other words, the traders bid for the right to claim the liquidity or availability to borrow shares to insure trading requirements is satisfied. The fees collected from the bids are paid to the share owners who are allowing the shares to be pre-borrowed and to the entity providing services for arranging the transaction (e.g., a software licensing fee). The auction may occur overnight or after trading has ended for the day so that the most current, static list of available shares can be generated.

When the trader has bid and won the right to borrow certain shares (e.g., by agreeing to pay the highest amount of fees), the shares are placed into an addressed account (e.g., digital wallet) associated with the Crypto Securities Platform. The empirical existence of shares is cryptographically signed and recorded on a distributed ledger. The Crypto Securities Platform then issues a digital token or digital coin referred to herein as a token or short token, which is a digital representation of the position of shares that are available for loan with a fee that will be recorded on trade day as specifically allotted to settle a particular short sale transaction towards the trader's account. “Token” and “short token” are used interchangeably throughout the disclosure.

Next, the ATS matches the trader's bid for pre-borrowing the shares with the short token. Once the transaction is matched, the short token is cryptographically signed (e.g., using public and private keys) from the digital registry (e.g., digital account, addressed account, digital wallet) of the Crypto Securities Platform to the digital registry of the trader or the trader's clearing firm. This transaction is recorded on the distributed ledger. Because the short token identifying the right to borrow the shares has been recorded on the ledger as being owned by the trader, no one can use those particular shares to fulfill a short sale order except the trader. Thus, when the trader is ready to settle on settlement day (i.e., the day the shares are due to the buyer), the short token will be applied to fulfill the trader's order (i.e., transferred to the buyer). That is, the short token cannot be applied to another account because the short token has been cryptographically transferred to the trader's account.

An additional benefit of the Crypto Securities Platform is the ability for the trader to liquidate the liquidity rights purchased by the trader. That is, the Crypto Securities Platform allows the trader to sell the right to sell the shares in a secondary market because the rights to the pre-borrowed shares are recorded on the distributed ledger. For example, after the short token is cryptographically signed to the trader, the trader can sell the short token (or a portion of the short token) to another trader. Because legacy systems lacked a way to indicate which shares were pre-borrowed, selling the right to sell the shares was not an available option.

The Crypto Securities Platform uses crypto ledgers (e.g., block chains) to verify ownership and availability of the short token. The short tokens may be transferred to other owners using cryptographic techniques such as public-key cryptography and bidirectional encryption. Public-key cryptography requires a key pair, where the two keys are mathematically linked. One key is a public key that is freely shared among nodes in a peer-to-peer network. The other key is a private key that is not shared with the public. The public key is used to encrypt plaintext and to verify a digital signature. The private key is used to decrypt cipher text and to digitally sign transactions. Transaction messages may be digitally signed by the sender's private key to authenticate the sender's identity. Then, the sender's digitally-signed transaction message may be decrypted using the sender's public key to verify that the sender originated the transaction.

Ownership of the shares may be based on ownership entries in distributed ledgers that are maintained by network nodes. The distributed ledgers (e.g., block chain for Bitcoin) record entries for each change of ownership of each short token and may be mathematically linked to the key pairs. To sell a short token, a transaction message (e.g., in packets or other data structures) may be broadcast to nodes on a peer-to-peer network. The transaction message can be signed by the seller's private key and may include information such as a history of the chain of title of the short token, the number of shares being borrowed and the purchaser's public key-based address. When a majority of the nodes in the network agree that the sender has the proper chain of title, ownership is changed to the purchaser and the ledger is updated to indicate the transaction.

The Crypto Securities Platform can be used to create ETFs and to prevent naked short selling of ETFs. An ETF is a marketable security that tracks an index, a commodity, bonds, or a basket of assets such as an index fund. ETFs have two levels of trading activity: primary and secondary. In the primary market, ETF authorized providers exchange a published basket of securities in-kind plus a published cash component in exchange for ETF shares. These baskets are generally very large, and one creation or redemption unit is equal to a fixed number of ETF shares. The ratio varies by product, but is usually 50,000 ETF shares per unit. ETFs can issue shares to or redeem shares from institutional investors (e.g., broker-dealers) in large blocks (e.g., 50,000 shares) called creation units. Creation unit transactions can be conducted in exchange for the deposit or delivery of a designated portfolio of in-kind securities and/or cash constituting a substantial replication, or a representation, of the securities included in the ETF's benchmark Index. Typically, individual shares of the ETF may only be purchased and sold on national securities exchanges, electronic crossing networks and other alternative trading systems through broker-dealers at market prices. Most institutional and retail clients trade ETF shares in the secondary market.

An ETF trades like a common stock on a stock exchange and therefore naked short selling of ETFs may occur. The process of preventing naked short selling described above using a short token may be used to prevent naked short selling of ETFs. Moreover, a similar mechanism may be used to ensure that the assets underlying ETF shares exist and can be obtained during the ETF creation process.

Because ETFs are comprised of various assets, in some embodiments, the various assets may be put up for auction prior to creating the ETF shares. In some embodiments, ETF authorized providers may be required to participate in an auction and/or tokenization process whereby the security lenders (e.g., custodians) put the underlying assets up for auction and/or create a short token component, thus ensuring that the underlying assets required to create the ETF shares are available to the ETF providers. A second auction process could then take place between security lenders lending the ETF shares and the short sellers desiring to short the ETF shares.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, for example, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

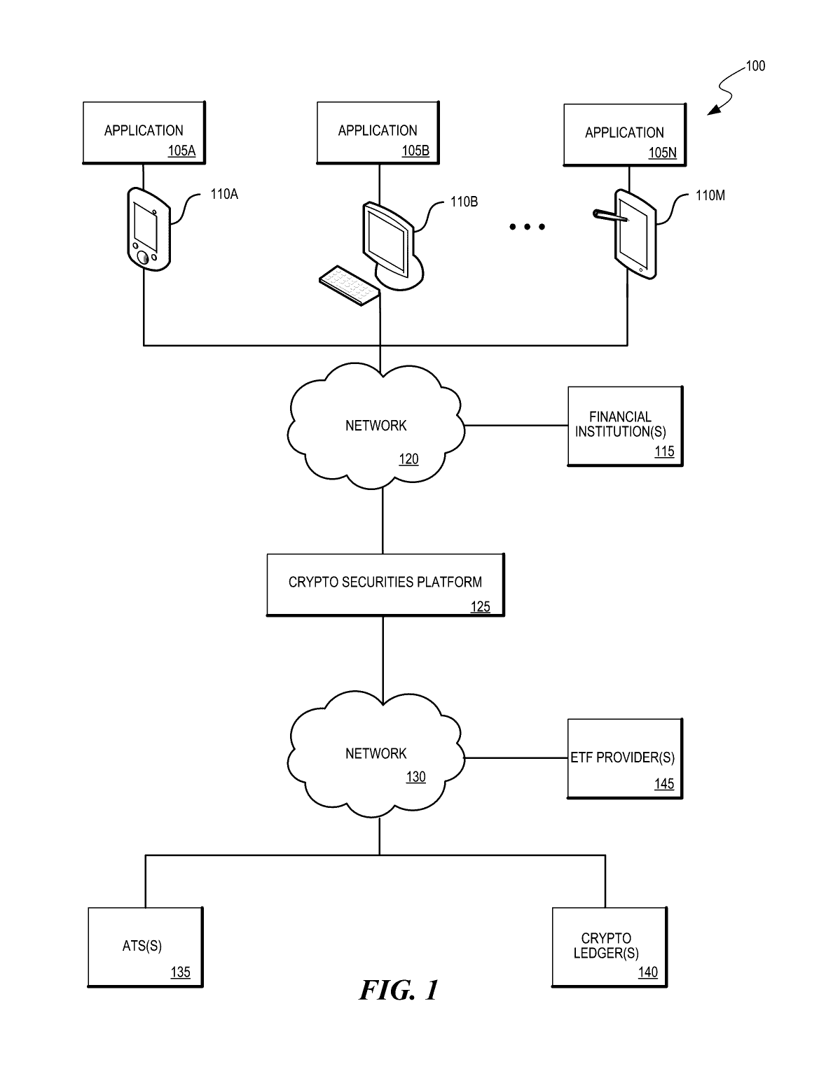

FIG. 1 illustrates an example of a network-based operating environment 100 in which some embodiments of the present disclosure may be used. As illustrated in FIG. 1, operating environment 100 includes applications 105A-105N running on one or more computing devices 110A-110M (such as a mobile device, a mobile phone, a tablet computer, a mobile media device, a mobile gaming device, a vehicle-based computer, a dedicated terminal, a public terminal, desktop, or laptop computer, a kiosk). In some embodiments, applications 105A-105N for carrying out operations such as bidding on pre-borrowed shares and generating short sale orders may be stored on the computing devices or may be stored remotely. These computing devices can include mechanisms for receiving and sending traffic by connecting through network 120 to Crypto Securities Platform 125, Financial Institution(s) 115, and ETF Provider(s) 145.

Computing devices 110A-110M are configured to communicate via network 120 with Financial Institution 115 and Crypto Securities Platform 125. In some embodiments, computing devices 110A-110M can retrieve or submit information to Crypto Securities Platform 125 and run one or more applications with customized content retrieved by Crypto Securities Platform 125 and Financial Institution(s) 115. For example, computing devices 110A-110M each can execute a browser application or a customized client to enable interaction between the computing devices 110A-110M and Crypto Securities Platform 125 and Financial Institution 115.

Users of computing devices 110A-110M may include entities (i.e., natural persons, companies, or other organizations) that engage in the business of trading assets (e.g., securities, mutual fund shares, commodities) for their own account or on behalf of their customers. Computing devices 110A-110M may communicate orders to Crypto Securities Platform 125 via network 120. The orders sent via computing devices 110A-110M may use the Financial Information eXchange (“FIX”) protocol or other known protocols and/or formats.

Financial Institution(s) 115 is one or more financial institutions having shares of securities in its control (e.g., Financial Institution(s) 115 can have clients who own assets being held at Financial Institution(s) 115). Preferably, Financial Institution(s) 115 is an institution with many (i.e., millions of) clients who own many (i.e., millions of) shares of stock and other securities (e.g., Industrial and Commercial Bank of China (“ICBC”)). In some embodiments, Financial Institution(s) 115 serves as a custodian to pension and retirement plans and endowments. In its role as custodian, Financial Institution(s) 115 may lend the right to borrow securities to one or more investors for a short sale to generate funds for their clients. In some embodiments, Financial Institution(s) 115 interacts with ETF Provider(s) 145 and Crypto Securities Platform 125 via networks 120 and 130 to lend or sell securities or other instruments used to create one or more ETFs.

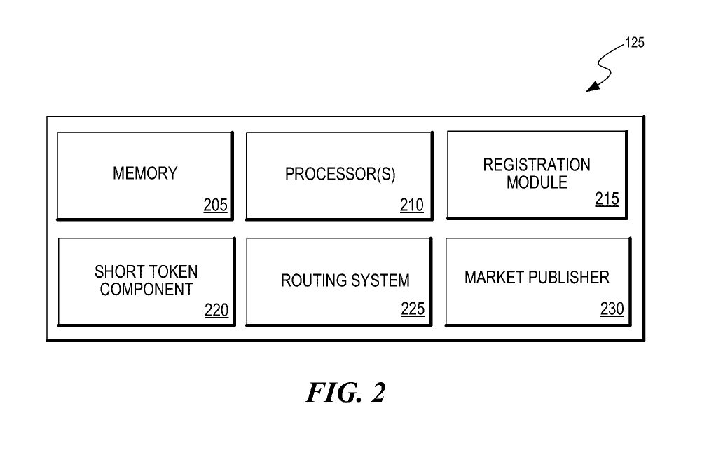

The Crypto Securities Platform 125 is communicably coupled with one or more alternative trading system(s) (“ATS(s)”) 135, Crypto Ledger(s) 140, and ETF Provider(s) 145 through network 130. The Crypto Securities Platform 125 can run on one or more servers and can be used to register securities into a digital registry that establishes and records ownership of the shares on a distributed ledger. Recording ownership and changes in ownership of the shares enables traders to make short sales with no risk of the trader being a naked short seller. In some embodiments, and as illustrated and introduced in FIG. 2, Crypto Securities Platform 125 includes a Registration Module 215, Short Token Component 220, Routing System 225, and Market Publisher 230.

Network 120 and network 130 can be the same network or can be separate networks and can be any combination of local area and/or wide area networks, using wired and/or wireless communication systems. Either network 120 or network 130 could be or could use any or more protocols/technologies: Ethernet, IEEE 802.11 or Wi-Fi, worldwide interoperability for microwave access (WiMAX), cellular telecommunication (e.g., 3G, 4G, 5G), CDMA, cable, digital subscriber line (DSL), etc. Similarly, the networking protocols used on network 120 and network 130 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 120 and network 130 may be represented using technologies, languages and/or formats including hypertext markup language (HTML) or extensible markup language (XML). In addition, some or all links can be encrypted using conventional encryption technologies such as secure sockets layer (SSL), transport layer security (TLS), and Internet Protocol security (IPsec).

ETF Provider(s) 145 can create new ETF shares. The new ETF shares may be created due to a lack of ETF share caused by naked short selling or for other market reasons. In some embodiments, ETF Provider(s) 145 can also redeem ETF shares. ETF Provider(s) 145 may receive the underlying shares for the ETF from Financial Institution 115(s) (or other custodian) via a prime broker, create the ETF shares, and route the ETF shares back to the prime broker to be pre-borrowed by investors. In some embodiments, the short token process may be used to ensure that the underlying shares of the ETF are available to create additional ETF shares. The short token process may also be used when short sellers are shorting the actual ETF shares.

ATS(s) 135 are non-exchange trading systems that find interested parties for transactions by matching buyers and sellers. ATS(s) 135 are alternatives to traditional stock exchanges. Examples of ATS(s) 135 include electronic communication networks (ECNs), crossing networks, dark pools, and call markets. ATS(s) 135 receive the number of shares and pricing for the pre-borrowed shares for an auction from the Crypto Securities Platform 125, hold the auction by receiving pre-borrow orders from customers using computing devices 110A-110M, inform Financial Institution 115 of the pre-borrow, match buy/sell order to borrow the shares (e.g., the bid with the short token), execute orders, and maintain a state of the order book which records the state of the orders. In some embodiments, ATS(s) 135 can act as an ETF provider whereas in other embodiments ATS(s) are separate from the ETF provider. ATS(s) 135 also create a secondary market for the pre-borrowed shares by allowing the short token to be traded just like a typical asset can be traded. Any quantity or subset amount of the short token can be re-traded. In some embodiments, a lowest round lot may be established (e.g., 100 shares). The activity on the ATS(s) 135 (e.g., auctions, trades, pre-borrows, executions) is recorded on Crypto Ledger(s) 140.

Crypto Ledger(s) 140 record economic transactions such as the pre-borrow of shares for the short sale, the short sale, and secondary sales of the right to sell the shares. In some embodiments, the shares that are put up for auction with the initial pricing is recorded to the ledger regardless of whether the shares are ultimately lent out to bidders. Crypto Ledger(s) 140 vary per unit. For example, Bitcoin uses a distributed public ledger called the block chain. When Crypto Ledger(s) 140 receive a transaction signed with the proper key from the Crypto Securities Platform 125 and the transaction is verified by network nodes, Crypto Ledger(s) 140 moves the assets to the proper address by recording the transaction (e.g., adding a block chain into the ledger).

Various data stores can be used to manage storage and access to digital securities, user information, and other data. The data stores may be distributed data stores such as Crypto Ledger(s) 140. The data stores may be a data repository of a set of integrated objects that are modeled using classes defined in database schemas. Data stores may further include flat files that can store data. The Crypto Securities Platform 125 and/or other servers may collect and/or access data from the data stores.

FIG. 2 illustrates a set of components within Crypto Securities Platform 125 according to one or more embodiments of the present disclosure. According to the embodiments shown in FIG. 2, Crypto Securities Platform can include memory 205, one or more processor(s) 210, Registration Module 215, Short Token Component 220, Routing System 225, and Market Publisher 230. Other embodiments may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, Short Token Component 220 and Routing System 225 can be combined into a single component.

Memory 205 can be any device, mechanism, or populated data structure used for storing information. In accordance with some embodiments of the present disclosure, memory 205 can be or include, for example, any type of volatile memory, nonvolatile memory, and dynamic memory. For example, memory 205 can be random access memory, memory storage devices, optical memory devices, magnetic media, floppy disks, magnetic tapes, hard drives, erasable programmable read-only memories (EPROMs), electrically erasable programmable read-only memories (EEPROMs), compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of Registration Module 215, Short Token Component 220, Routing System 225, and/or Market Publisher 230.

Registration Module 215 creates a digital record of ownership of shares (i.e., a registry). For example, an endowment or retirement fund may choose to have ownership of their assets recorded on a distributed ledger, providing an additional method of verifying ownership. When ownership (or a right associated with ownership) of the shares is transferred, the transaction can be recorded on the digital ledger. Registration Module 215 may also record a price at which the shares were purchased, sold, or lent. Showing ownership and pricing may provide an easy way for beneficial owners of securities to evaluate how well custodians are fulfilling their fiduciary duties (e.g., should custodians have been selling short tokens).

Short Token Component 220 may collect information for an auction and issue short tokens to a master digital account. In particular, Short Token Component 220 may request information (e.g., a file) from a financial institution (e.g., Financial Institution 115) that includes the shares that the financial institution has in its possession and control that the financial institution deems available for pre-borrowing for a short sale. Short Token Component 220 also provides pricing for the right to borrow the shares. This fee will be paid to the owners of the shares. In some embodiments, an additional fee may be assessed for use of the software to maintain the registry, arrange the auction, communicate with the traders, and issue the short token. Thus, a baseline price (i.e., minimum fee that includes the fees paid to all the stakeholders) is established for the right to borrow the shares. In some embodiments, the auction information (i.e., shares and pricing) is requested at the end of a trading day and will remain good until the market opens again the following day and thus the auction is an overnight auction. The financial institution may provide the information (e.g., inventory file) to Short Token Component 220.

Thereafter, Short Token Component 220 may create and post pricing for an auction to ATS(s) 135. During the auction, traders bid on the amount of fees to borrow securities. The fees pay for the unmitigated right to short the particular shares and create an exclusive commitment to deliver the shares on settlement day. The highest bidder (i.e., the bidder willing to pay the highest fees) wins the bid. In some embodiments, the auction is a Dutch auction. During a Dutch auction, shares are posted to the ATS(s) 135, divided into units (e.g., 100,000 total shares available with 10 units of 100 shares) and priced (e.g., $120 for each unit). If ten bidders bid $120/unit and no one else bids higher, then the ten bidders purchased the right to sell those shares. If, before the auction is over, another bidder places a higher bid (e.g., $130/unit), the bidder bidding the higher amount will have won as many units as the bidder bids on. In some embodiments, the bidding is recorded to the distributed ledger.

After indications of interest to pre-borrow shares are received by ATS(s) 135, the corresponding physical quantity of shares is received in the custody of an account associated with the Short Token Component 220 at a registered Broker-Dealer. This transfer is recorded to the distributed ledger. Once the physical quantity of shares are received into the custody of the account associated with the Short Token Component 220, Short Token Component 220 issues a short token, which is an encrypted digital representation recorded on the distributed ledger. The short token can identify the position of shares that are available for loan, the bid price for the short token (i.e., the winning bid amount to pre-borrow the shares), and the identity of the lender of the shares (i.e., custodian and/or beneficial owner of the shares).

The short token is authenticated by the custodial location and control of Depository Trust Control (“DTC”) eligible shares. Empirical evidence of authentication is provided by the fact that a Depository Trust Control member Financial Industry Regulation Authority (“FINRA”) firm identifies a corresponding amount of physical shares and transfers the custodial position of the shares to the account associated with the Short Token Component. Thus, the short token identifies the shares specifically made available by the lender and assigns the right to short against those shares eliminating the risk of failure to deliver when shorting a security. When the short token is matched with the bid, the short token is cryptographically signed to a registry/account/wallet associated with the bidder.

In some embodiments, Short Token Component 220 may issue one or more short tokens for the underlying securities of an ETF share. In such cases, after the security lender (e.g., custodians/financial institution) puts the underlying assets up for auction, Short Token Component 220 can issue a short token to the ETF provider to ensure that the underlying assets required to create the ETF shares are available to the ETF provider. In some embodiments, a short token may be issued without the auction process.

Short tokens may be stored in an addressed account (e.g., digital wallet) associated with Short Token Component 220. The digital wallet may have a key pair having a private key and a public key. The two parts of the key pair are mathematically linked. The public key of a key pair may be published without compromising security, whereas the private key of a key pair must not be revealed to anyone not authorized to read messages or perform digital signatures.

In some embodiments, additional wallets may be created within the Short Token Component 220. For example, certain traders, broker-traders, or financial institutions may have particular wallets associated with the digital wallet. Short tokens may be deposited in these particular wallets, indicating that the shares are allocated to a certain person or certain short sale. Short Token Component 220 may include keys for different public ledgers thereby providing one master account per customer, financial institution or broker-dealer. After the short token is issued, Short Token Component 220 communicates the final auction pricing to the ATS(s) 135.

Routing System 225 provides an interface between customer computing devices and the ATS(s) 135, allowing customers to place bids to pre-borrow shares and to buy and sell short tokens on the ATS(s) 135. Customers can view their short tokens and their buy/sell orders using Routing System 225. Additionally, once a short token has been issued and associated with the customer (e.g., placed in the customer's digital wallet), the transaction is published by the Market Publisher 230, allowing for the short token (or a portion of the short token) to be bought or sold by customers on the ATS(s) 135 through Routing System 225. If only a portion of the short token is to be sold in the secondary market, a new token indicating the portion of the securities to be transferred may be generated.

In some embodiments, Routing System 225 acts as a prime broker or authorized participant for ETF Provider(s) 145 by receiving underlying securities for an ETF from financial institutions or other custodians and providing the underlying securities to ETF Provider 145. After the ETF Provider(s) 145 creates the ETF shares, ETF Provider 145 may provide the shares to Routing System 225.

Market Publisher 230 may receive drop copy market data from the ATS(s) 135 once the short token is matched with the order for pre-borrowed shares. Generally, ATSs are not permitted to publish securities transaction data. Therefore, when an auction is complete and the short token is matched with the bid, the short token transaction (e.g., including the bid price for the short token and the identity of the pre-borrowed shares) is published to Market Publisher 145. Market Publisher 145 publishes the data to financial institutions, broker-dealers, and others allowing traders to see that the borrowed shares are allocated to a particular account (i.e., there will not be a naked short sale) and further allowing for additional trades on the liquidity to occur.

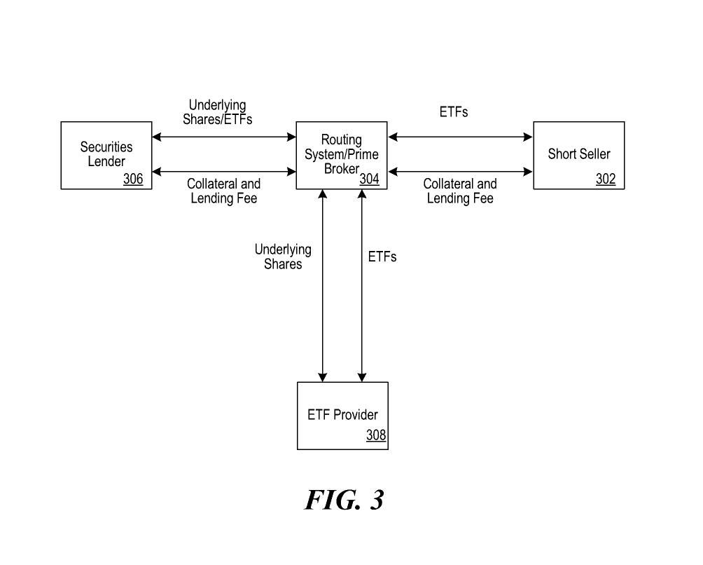

FIG. 3 is a diagram presenting an overview of a create-to-lend process for ETF short selling. In a standard (i.e., non-ETF) short selling transaction, a short seller (302) approaches a prime broker (e.g., a routing system) (304) to borrow a security, commodity, currency or other asset to short sell. The prime broker (304) obtains the security from a lender (e.g., an institutional investor) (306) in exchange for collateral and a fee. The fee can be passed onto the short seller (302). When an ETF is to be shorted, the process is similar except that ETFs may be even more difficult to borrow due to lack of supply. However, unlike other securities, ETFs can be created so long as the underlying assets are available. Thus, when more ETF shares are needed, the prime broker can borrow the underlying securities and pass them onto the ETF provider (308). The ETF provider can create new ETF shares which can subsequently be given to the short seller (302).

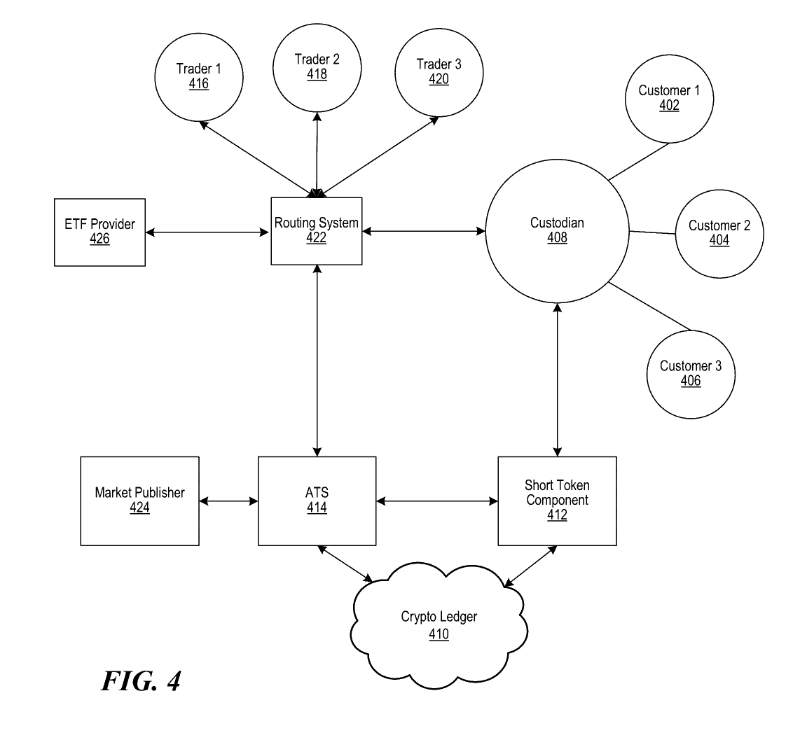

FIG. 4 is a diagram illustrating interaction of components used in pricing the lending and borrowing of shares for a short sale and recording the lending and borrowing of shares for the short sale in a digital registry. Assume that beneficial owners (e.g., Customer 1 (402), Customer 2 (404), and Customer 3 (406)) of securities held at a custodian (408) have registered ownership in their securities with a distributed ledger (e.g., Crypto Ledger (410)). Short Token Component (412) receives inventory available for auction and the pricing for the right to borrow the securities in the inventory from the custodian (408). Short Token Component (412) communicates the pricing and the inventory to the ATS (414). Via the Routing System (422), traders (e.g., Trader 1 (416), Trader 2 (418), Trader 3 (420)) can view the auction and make bids on the right to borrow the shares. The ATS (414) communicates winning bidders and the price the winners will pay for the right to borrow the shares to the custodian (408) via the Routing System (422) or directly. The custodian (408) places custody of the shares into a digital registry associated with the Short Token Component (412). Then Short Token Component (412) issues a short token representing the shares that are pre-borrowed for a fee. The ATS (414) matches the short token with the trader's bid. During this transaction, the short token is cryptographically signed into the trader's (or trader's firm's) digital registry. The trade is published by the Market Publisher (424), allowing other traders to make further offers on the short token.

In some embodiments that involve ETFs, additional ETF shares are needed to cover short sales or simply to satisfy demand of the ETF shares. To create additional ETF shares (e.g., in response to a customer request via the custodian (408)), the ETF Provider (426) may request the underlying shares from the Routing System (422), which can act as prime broker or authorized participant for the ETFs. The Routing System (422) can then request the underlying shares from the custodian (408) and after receiving the underlying shares, the Routing System (422) can provide them to the ETF Provider (426). The ETF Provider (426) can create the ETF shares from the underlying shares. Thereafter, the custodian (408) can provide these shares customers, where they can be shorted, sold, or held.

In some embodiments, the custodian (408) may hold an auction in which the ETF Provider (426) bids on the underlying assets of the ETFs and a short token is created for the underlying assets prior to ETF creation. In some embodiments, no auction is held, but a short token is still created for the underlying assets of the ETFs to ensure that the underlying assets are actually available for ETF creation.

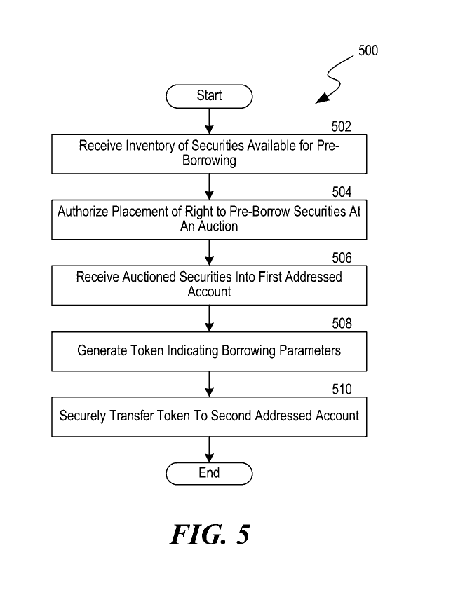

FIG. 5 is a flowchart 500 of a short token process from the perspective of a Crypto Securities Platform. In some embodiments, fewer than all of the operations are performed, whereas in other embodiments additional operations are performed. Moreover, in some embodiments, the operations may be performed in different orders or in parallel. The operations can be performed by various components in FIG. 2 such as memory 205, processor(s) 210, Registration Module 215, Short Token Component 220, Routing System 225, and Market Publisher 230.

Receiving operation 502 receives an inventory of securities available for pre-borrowing. Such inventory can be received by various entities such as a financial institution. In some embodiments, the inventory is received periodically (e.g., every evening). Authorizing operation 504 authorizes placement of the right to pre-borrow the securities at an auction. The auction may occur periodically (e.g., nightly). Authorizing operation 504 may further provide a baseline price (e.g., fee payable to the securities owner for the right to pre-borrow, fee payable to software provider and/or ATS for using the system) and quantity at which the bidding can start. After the auction occurs, the auctioned securities are received from a banking account of the owner or beneficial owner of the securities into a first addressed account associated with the token generator in receiving operation 506. The securities can be cryptographically signed (e.g., using a private key of an addressed account of the bank and/or owner) and the transaction can be recorded on a distributed ledger.

Once the securities are associated with the first addressed account, the system creates a token that indicates one or more borrowing parameters in generating operation 508. The borrowing parameters can include an identity of the one or more securities auctioned to the bidder, a bid amount to pre-borrow the one or more securities, and an owner or beneficial owner of the one or more securities. In some implementations, the system can receive confirmation from a distributed ledger that the one or more securities is associated with the first addressed account prior to generating the token. After the token is generated, the token can be cryptographically or securely transferred to a second addressed account associated with the successful bidder in transferring operation 510. The transaction can be cryptographically signed with a private key of the first addressed account and the transaction can be communicated to the distributed ledger for recordation. In some embodiments, a final auction price can be provided to an alternative trading system, along with the authorization of a resale of the token in a secondary market.

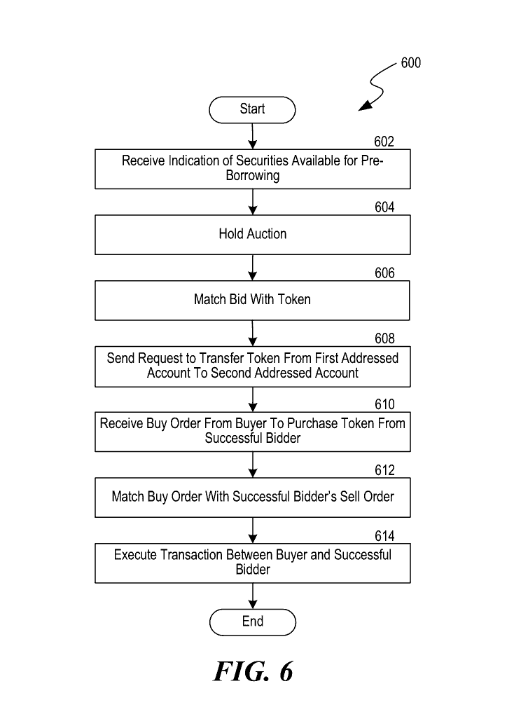

FIG. 6 is a flowchart 600 from the perspective of an ATS (e.g., ATS(s) 135) in accordance with one or more embodiments of the present disclosure. In some embodiments, fewer than all of the operations are performed, whereas in other embodiments additional operations are performed. Moreover, in some embodiments, the operations may be performed in different orders or in parallel.

Receiving operation 602 receives an indication of securities available for pre-borrowing. Holding operation 604 holds an auction to auction the right to pre-borrow the shares. The system may receive a baseline price and/or quantity for auctioning the securities. Auctioning can include receiving bids for a right to pre-borrow the one or more securities, and determining a successful bidder. Matching operation 606 matches the bid with a token that identifies the securities associated with the bid, an owner or beneficial owner the securities, and a bid price for the right to pre-borrow the securities. The token can be associated with a first addressed account. In some embodiments, prior to matching the bid, the system receives confirmation from a distributed ledger that the token is associated with the first addressed account.

Sending operation 608 sends a request (e.g., to a computer system) to securely transfer the token to a second addressed account associated with the successful bidder (e.g., cryptographically signed using a private key of the first addressed account) and can be communicated to a distributed ledger for recordation. In some embodiments, the seller may choose to sell the token in a secondary market. Receiving operation 610 receives a buy order to purchase the token. Thereafter, the buy order is matched with the successful bidder's sell order in matching operation 612. Executing operation 614 executes the transaction between the buyer and the successful bidder. The token can then be securely transferred from the second addressed account to a third addressed account associated with the buyer. The buyer can choose to sell the token (or a portion of the token), which would then be transferred from the third addressed account to a fourth addressed account. Each transaction can be recorded to the distributed ledger.

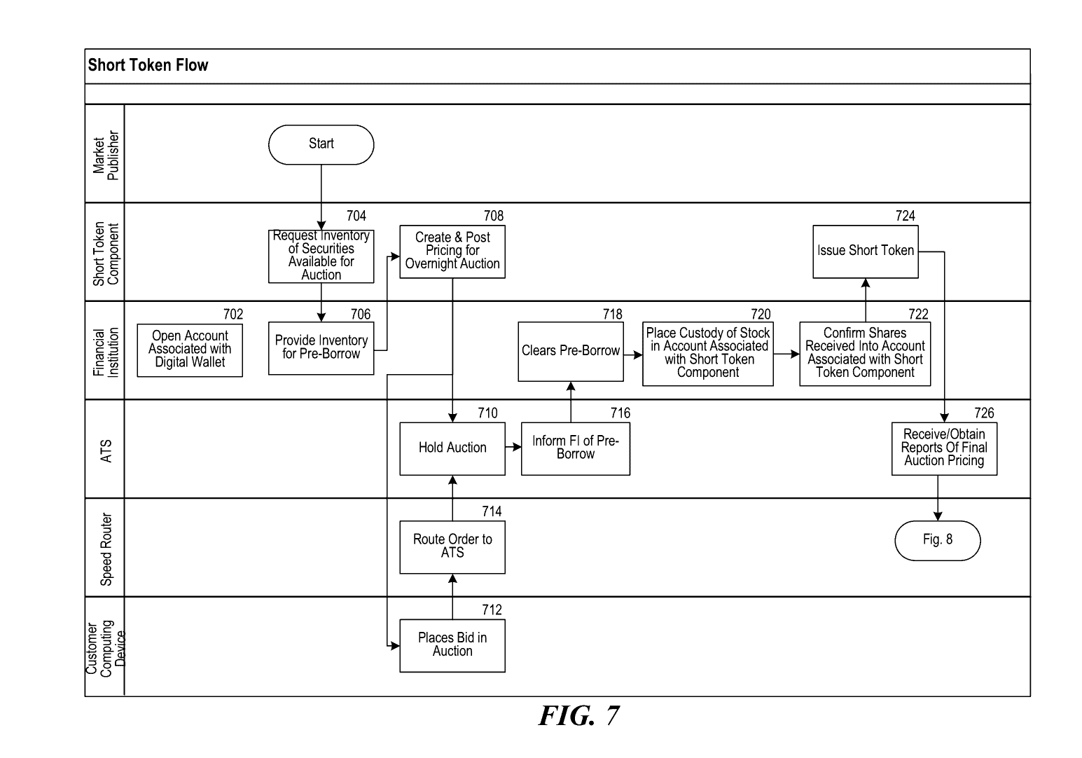

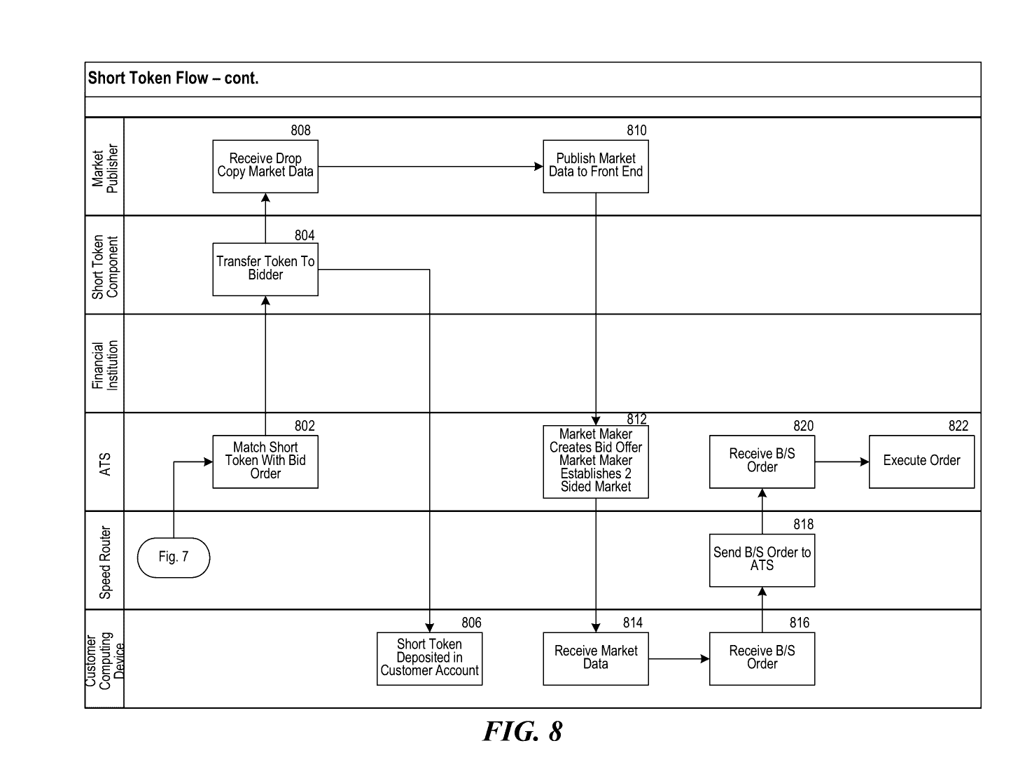

FIGS. 7-8 illustrate a process of creating a digital registry through a distributed ledger, pricing the lending and borrowing of shares for a short sale, and recording the lending and borrowing of shares for the short sale in the digital registry. Beginning with FIG. 7, shares owned by the financial institution's clients are recorded into a digital registry (702), with an indication of ownership of the shares. A short token component (e.g., Short Token Component 220) requests data from a financial institution (e.g., Financial Institution(s) 115) regarding the securities (e.g., type, quantity) that are available for pre-borrowing and the pricing for lending the securities (704). The financial institution provides the inventory information (706). For example, the financial institution may state that the financial institution will allow a short seller to pre-borrow 10,000 shares for $0.20/share. The short token component uses this information and adds on any additional fees such as a fee of $0.10/share for providing the software (e.g., to create an auction, issue the short token). Thus, the cost of pre-borrowing shares for a short sale of 10,000 shares may be $3,000. After receiving the information, the short token component then posts the shares and the baseline pricing for borrowing the shares (708).

Next, an auction is held on an ATS (e.g., ATS(s) 135) in which the right to pre-borrow shares is auctioned (710). The short seller (i.e., customers), entities, investors, and others can view the posted prices and shares for the auction via a routing system (e.g., Routing System 225). Customers can place bids (712) that are routed via orders to the ATS (714). After the auction is held (710), the ATS communicates successful bids to the financial institution (716). For example, if the price of pre-borrowing 10,000 shares is $3,000 and the short seller agrees to pay this fee, then such information is communicated to the financial institution.

Assuming the financial institution agrees with the bid (i.e., that the bid clears the financial institution) (718), the financial institution associates or places the physical pre-borrowed shares with or into an addressed (i.e., digital) account associated with the short token component (720). The transaction is recorded to a distributed ledger. Recording the transfer to the ledger can be done by cryptographically signing (e.g., using key pairs) ownership from the financial institution (or its client) to the addressed account associated with the short token component. The short token component can confirm that the shares have been transferred to the addressed account by checking the digital ledger (722). After verifying that the shares are associated with the addressed account associated with the short token component, the short token component issues a short token which digitally represents the pre-borrowed shares that can be provided on settlement day of the short sale and credited towards the customer's account (724). The short token component can further include the fee breakdown (e.g., amount paid to pre-borrow the shares, amount of additional fees, identity of owner of the pre-borrowed shares) in the short token. The short token component can communicate with the distributed ledger to have the existence and ownership of the short token recorded to the distributed ledger. By recording the short token on the digital ledger, the short token component records that the shares have been pre-borrowed, including the fee associated with the pre-borrowing. The ATS can check the distributed ledger to verify the information. The ATS can receive reports of the final auction pricing via the short token component or via the distributed ledger (726).

Continuing to FIG. 8, the ATS matches the short seller's bid with the short token (802). After the matching, the short token is transferred from the addressed account associated with the short token component to an addressed account associated with the short seller (804). This can be done by the short token component cryptographically signing the transaction using a private key of the addressed account associated with the short token component and a public address of the customer). Thus, after the transfer, the short token is associated with an addressed account of the short seller (806). The transfer transaction is recorded to the digital ledger.

The market publisher (e.g., Market Publisher 230) also receives data regarding the transaction from the ATS (or the short token component), including the short token identifying the pre-borrowed shares and the price paid to pre-borrow the shares (808), and publishes this data to the market (810). This market data may be made available to the short seller and others via the routing system, establishing a two sided market such that the short seller can trade the short token (812). Thus, should the short seller want to sell the right to the pre-borrowed security (or borrow someone else's right to pre-borrow), the short seller can authorize a trade for the short token via the ATS. Effectively, the ATS makes the short token available for re-sale in the market. The short token may be re-sold over and over until the short sale is executed, with each transaction being recorded on the digital ledger to document who has the right to the pre-borrowed shares.

For example, if the short seller paid $3,000 to short 10,000 shares of stock and made $5,000 in the process (net of $2,000), the short seller may wish to sell the pre-borrowed shares to recuperate some of the transaction costs. Another short seller may wish to purchase the right to sell the pre-borrowed shares for $1000 because the second short seller believes that the stock may plummet further. This allows the first short seller to net $3,000 instead of netting only $2,000.

As shown in FIG. 8, the bidder may receive market data from the ATS (814), including an order offering to purchase the token (816) via the speed router (818). Or, the bidder may send an order to sell the token to the ATS (816) via the speed router (818). Once the ATS receives the buy or sell order and matches the order to a second order (820), the ATS executes the order (822).

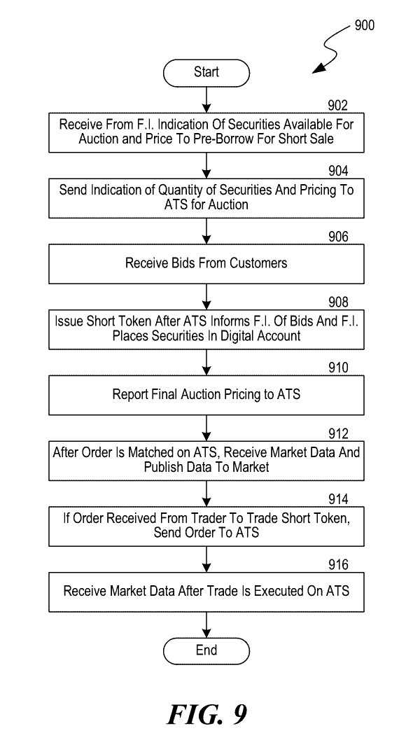

FIG. 9 is a flowchart 900 of a short token process from the perspective of a Crypto Securities Platform. In some embodiments, fewer than all of the operations are performed, whereas in other embodiments additional operations are performed. Moreover, in some embodiments, the operations may be performed in different orders or in parallel. The operations can be performed by various components in FIG. 2 such as memory 205, processor(s) 210, Registration Module 215, Short Token Component 220, Routing System 225, and Market Publisher 230.

Receiving operation 902 receives an indication of securities available for auction and the price to pre-borrow the securities before a short sale is executed. Sending operation 904 sends the indication of the securities available for auction and the price to pre-borrow the securities to an ATS (e.g., ATS(s) 135) to hold the auction. Receiving operation 906 receives bids for the pre-borrowed securities from customers and sends the bids to the ATS. Issuing operation 908 issues a short token representing the pre-borrowed securities after the ATS informs the financial institution (e.g., Financial Institution 115) of the bids and after the financial institution physically and cryptographically signs the securities to a digital account set aside for the particular short sale. Once the short token is issued, the final auction pricing is reported to the ATS in reporting operation 910.

After the order for the pre-borrow is matched with the short token on the ATS, market data is received from the ATS and published, making the short token public in publishing operation 912. Sending operation 914 sends an order to the ATS to trade the short token if such an order is received. Receiving operation 916 receives the updated market data if an additional trade is executed on the ATS.

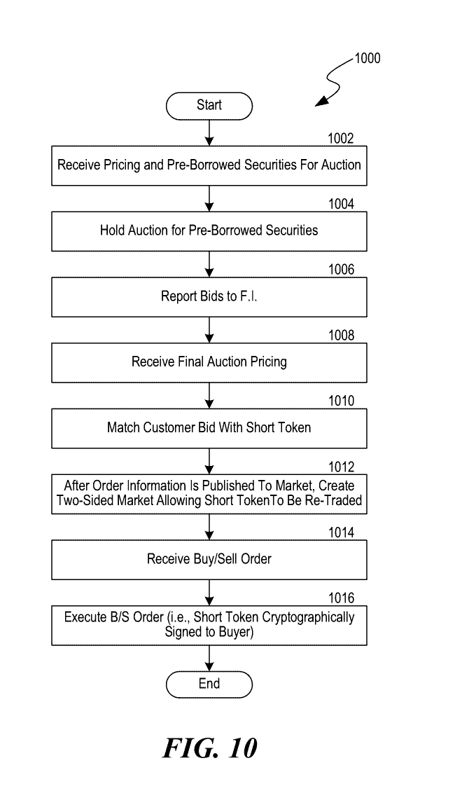

FIG. 10 is a flowchart 1000 from the perspective of an ATS (e.g., ATS(s) 135) in accordance with one or more embodiments of the present disclosure. In some embodiments, fewer than all of the operations are performed, whereas in other embodiments additional operations are performed. Moreover, in some embodiments, the operations may be performed in different orders or in parallel.

Receiving operation 1002 receives pricing for an auction of pre-borrowed securities to be presented to short sellers who wish to allocate shares that they will be responsible for providing to buyers. Holding operation 1004 holds an auction for the pre-borrowed securities in which bids are received from customers. Reporting operation 1006 reports the bids to the financial institution (e.g., Financial Institution(s) 115) offering the right to pre-borrow the shares. After the pre-borrowed shares have been cryptographically allocated to a digital account such that the shares cannot be allocated to fulfill another short seller's obligations, the ATS receives the final pricing associated with the pre-borrowed shares in receiving operation 1008. Matching operation 1010 matches the customer's order for a short sale with a buyer. Creating operation 1012 creates a market that allows the short token to be re-traded. Receiving operation 1014 receives a buy or sell offer from a customer offering to buy or sell the short token. Executing operation 1016 executes the short sale order and cryptographically signs the shares from the current owner of the short token to the buyer of the shares.

Various embodiments of the present technology are described below:
1. A computerized method comprising:
   receiving inventory of one or more securities available for pre-borrowing;
   authorizing placement of a right to pre-borrow the one or more securities at an auction administered by an alternative trading system;
   receiving, into a first addressed account associated with a token generator, the one or more securities that have been auctioned to a bidder;
   in response to receiving the one or more securities into the first addressed account, generating a token indicating one or more borrowing parameters; and
   upon receiving notification from the alternative trading system that the token is matched with a bid, cryptographically signing a transaction to transfer the token to a second addressed account associated with the bidder.
2. The computerized method of claim 1, wherein cryptographically signing the transaction to transfer the token comprises electronically signing, with a private key of the first addressed account, and wherein the computerized method further comprises generating baseline pricing for the right to pre-borrow the one or more securities, wherein the baseline pricing is a price at which bidding can begin.
3. The computerized method of claim 2, wherein the baseline pricing includes a fee payable to an owner of the one or more securities, wherein the computerized method further comprises paying the fee to the owner of the one or more securities when the one or more securities has been pre-borrowed.
4. The computerized method of claim 1, wherein the one or more borrowing parameters includes an identity of the one or more securities auctioned to the bidder, a bid amount to pre-borrow the one or more securities, and an owner or beneficial owner of the one or more securities, and wherein the method further comprises: sending, to a distributed ledger, a request to record the token and ownership of the token on the distributed ledger.
5. The computerized method of claim 4, further comprising: communicating, to the distributed ledger for recordation, the transaction to transfer the token to the second addressed account associated with the bidder.
6. The computerized method of claim 1, further comprising: before generating the token, receiving confirmation from a distributed ledger, that the one or more securities is associated with the first addressed account.
7. The computerized method of claim 1, further comprising:
   communicating a final auction price to the alternative trading system; and
   authorizing a resale of the token in a secondary market.
8. The computerized method of claim 1, wherein the one or more securities comprises at least two different securities to be used to create one or more shares of an exchange traded fund.
9. A non-transitory computer-readable storage medium comprising a set of instructions that, when executed by one or more processors, cause a machine to:
   receive inventory of one or more securities available for pre-borrowing;
   authorize placement of a right to pre-borrow the one or more securities at an auction administered by an alternative trading system;
   receive, into a first addressed account associated with a token generator, the one or more securities that have been auctioned to a bidder;
   in response to receiving the one or more securities into the first addressed account, generate a token indicating one or more borrowing parameters; and
   upon receiving notification from the alternative trading system that the token is matched with a bid, cryptographically sign a transaction to transfer the token to a second addressed account associated with the bidder.
10. The non-transitory computer-readable storage medium of claim 9, wherein the set of instructions that, when executed by the one or more processors, cause the machine to cryptographically sign the transaction to transfer the token further cause the machine to:
   electronically sign, with a private key of the first addressed account; and
   generate baseline pricing for the right to pre-borrow the one or more securities, wherein the baseline pricing is a price at which bidding can begin.
11. The non-transitory computer-readable storage medium of claim 10, wherein the baseline pricing includes a fee payable to an owner of the one or more securities, wherein the set of instructions that, when executed by the one or more processors, cause the machine to pay the fee to the owner of the one or more securities when the one or more securities have been pre-borrowed.
12. The non-transitory computer-readable storage medium of claim 9, wherein the one or more borrowing parameters includes an identity of the one or more securities auctioned to the bidder, a bid amount to pre-borrow the one or more securities, and an owner or beneficial owner of the one or more securities, and wherein the set of instructions, when executed by the one or more processors, further cause the machine to send, to a distributed ledger, a request to record the token and ownership of the token on the distributed ledger.
13. The non-transitory computer-readable storage medium of claim 12, wherein the set of instructions, when executed by the one or more processors, further cause the machine to communicate, to the distributed ledger, the transaction transferring the token to the second addressed account associated with the bidder.
14. The non-transitory computer-readable storage medium of claim 9, wherein the set of instructions, when executed by the one or more processors, further cause the machine to receive, before generating the token, confirmation from a distributed ledger that the one or more securities is associated with the first addressed account.
15. The non-transitory computer-readable storage medium of claim 9, wherein the set of instructions, when executed by the one or more processors, further cause the machine to:
   communicate a final auction price to the alternative trading system; and
   authorize a resale of the token in a secondary market.
16. A computerized method comprising:
   receiving, at an alternative trading system, an indication of one or more securities available for pre-borrowing through an auction;
   holding the auction at the alternative trading system;
   matching, by the alternative trading system, the bid with a token identifying the one or more securities, an owner or beneficial owner of the one or more securities, and a bid price for the right to pre-borrow the one or more securities, the token being associated with a first addressed account; and
   sending, to a computer system, a request to cryptographically transfer the token into a second addressed account associated with the successful bidder and to record the transfer to a distributed ledger.
17. The computerized method of claim 16, further comprising: prior to matching the bid, receiving confirmation from a distributed ledger that the token is associated with the first addressed account.
18. The computerized method of claim 16, wherein holding the auction at the alternative trading system comprises receiving one or more bids for a right to pre-borrow the one or more securities, and matching a successful bidder with a bid.
19. The computerized method of claim 16, further comprising:
   receiving a buy order to purchase the token from a buyer and a sell order to sell the token from the successful bidder;
   matching the buy order with the sell order; and
   executing a transaction between the buyer and the successful bidder to transfer the token to the buyer, wherein the token is electronically transferred from the successful bidder to the buyer when the successful bidder electronically signs the transaction.
20. The computerized method of claim 16, further comprising: communicating the transaction to a distributed ledger for recordation.
21. The computerized method of claim 16, wherein the one or more securities comprises at least two different securities to be used to create one or more shares of an exchange traded fund.
22. A non-transitory, computer-readable storage medium comprising a set of instructions that, when executed by one or more processors, cause a machine to:
   receive, at an alternative trading system, an indication of one or more securities available for pre-borrowing through an auction;
   hold an auction at the alternative trading system;
   match, by the alternative trading system, the bid with a token identifying the one or more securities, an owner or beneficial owner of the one or more securities, and a bid price for the right to pre-borrow the one or more securities, the token being associated with a first addressed account;
   send, to a computer system, a request to cryptographically transfer the token into a second addressed account associated with the successful bidder and to record the transfer to a distributed ledger;
   receive a buy order to purchase the token from a buyer and a sell order to sell the token from the successful bidder;
   match the buy order with the sell order; and
   execute a transaction between the buyer and the successful bidder to transfer the token to the buyer, wherein the token is electronically transferred from the successful bidder to the buyer when the successful bidder electronically signs the transaction.
23. A non-transitory computer-readable storage medium comprising a set of instructions that, when executed by one or more processors, cause a machine to:
   receive a request to create shares of exchange traded fund, the exchange traded fund comprising at least two different types of securities;
   authorize placement of a right to pre-borrow the at least two different types of securities an at an auction administered by an alternative trading system;
   receive, into a first addressed account associated with a token generator, the one or more securities that have been auctioned to a bidder;
   in response to receiving the one or more securities into the first addressed account, generate a token indicating one or more borrowing parameters; and
   upon receiving notification from the alternative trading system that the token is matched with a bid, cryptographically sign a transaction to transfer the token to a second addressed account associated with the bidder.

### Computer System Overview

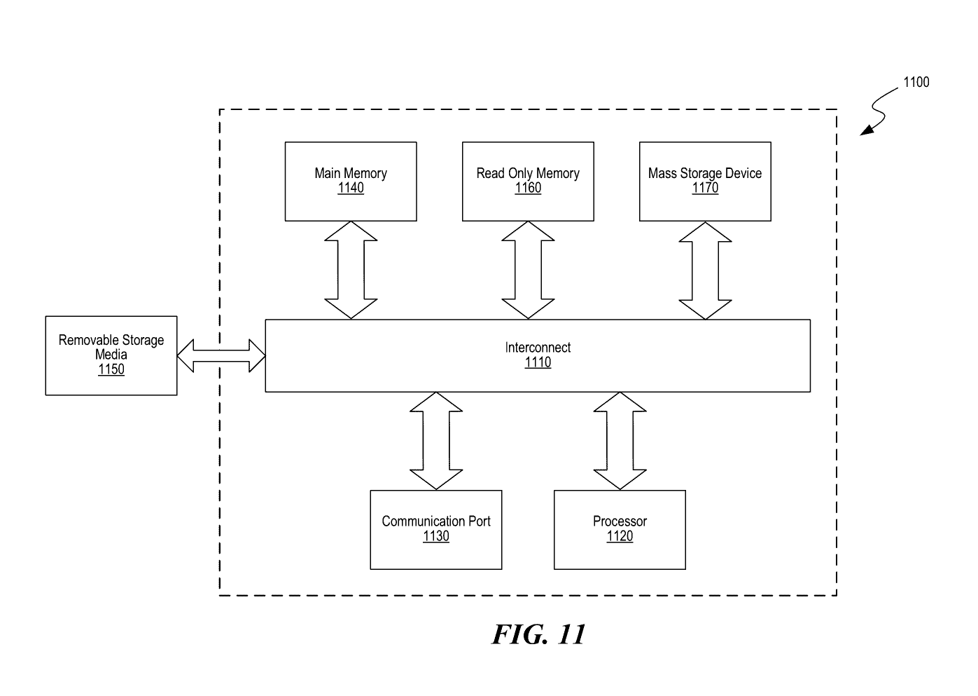

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 11 is an example of a computer system 1100 with which embodiments of the present disclosure may be utilized. According to the present example, the computer system 1100 includes an interconnect 1110, at least one processor 1020, at least one communication port 1030, a main memory 1140, a removable storage media 1050, a read only memory 1060, and a mass storage device 1170.

Processor(s) 1120 can be any known processor. Communication port(s) 1030 can be or include, for example, any of an RS-232 port for use with a modem-based dialup connection, a 10/100 Ethernet port, or a Gigabit port using copper or fiber. The nature of communication port(s) 1130 may be chosen depending on a network such a Local Area Network (LAN), Wide Area Network (WAN), or any network to which the computer system 1000 connects.

Main memory 1140 can be Random Access Memory (RAM), or any other dynamic storage device(s) commonly known in the art. Read only memory 1160 can be any static storage device(s) such as Programmable Read Only Memory (PROM) chips for storing static information such as instructions for processor 1120.

Mass storage device 1170 can be used to store information and instructions. For example, hard disks such as the Adaptec® family of SCSI drives, an optical disc, an array of disks such as RAID, such as the Adaptec family of RAID drives, or any other mass storage devices may be used.

Interconnect 1110 can be or include one or more buses, bridges, controllers, adapters, and/or point-to-point connections. Interconnect 1110 communicatively couples processor(s) 1120 with the other memory, storage, and communication blocks. Interconnect 1110 can be a PCI/PCI-X or SCSI based system bus depending on the storage devices used.

Removable storage media 1150 can be any kind of external hard-drives, floppy drives, Compact Disc-Read Only Memory (CD-ROM), Compact Disc-Re-Writable (CD-RW), Digital Video Disc-Read Only Memory (DVD-ROM).

The components described above are meant to exemplify some types of possibilities. In no way should the aforementioned examples limit the disclosure, as they are only exemplary embodiments.

### TERMINOLOGY

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “embodiments,” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the method and apparatus described herein are equally applicable to other systems, devices, and networks as one skilled in the art will appreciate. As such, the illustrated applications of the embodiments of the present disclosure are not meant to be limiting, but instead are examples. Other systems, devices, and networks to which embodiments of the present disclosure are applicable include, for example, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

In conclusion, the present disclosure provides novel systems, methods, and arrangements for creating a digital record of shares that are available to loan. While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

What is claimed is:

1. A computerized method comprising:
receiving inventory of one or more securities available for pre-borrowing;
authorizing placement of a right to pre-borrow the one or more securities at an auction administered by an alternative trading system;
receiving, into a first addressed account associated with a token generator, the one or more securities that have been auctioned to a bidder;
in response to receiving the one or more securities into the first addressed account, generating a token indicating one or more borrowing parameters; and
upon receiving notification from the alternative trading system that the token is matched with a bid, cryptographically signing a transaction to transfer the token to a second addressed account associated with the bidder.

2. The computerized method of claim 1, wherein cryptographically signing the transaction to transfer the token comprises electronically signing, with a private key of the first addressed account, and wherein the computerized method further comprises generating baseline pricing for the right to pre-borrow the one or more securities, wherein the baseline pricing is a price at which bidding can begin.

3. The computerized method of claim 2, wherein the baseline pricing includes a fee payable to an owner of the one or more securities, wherein the computerized method further comprises paying the fee to the owner of the one or more securities when the one or more securities has been pre-borrowed.

4. The computerized method of claim 1, wherein the one or more borrowing parameters includes an identity of the one or more securities auctioned to the bidder, a bid amount to pre-borrow the one or more securities, and an owner or beneficial owner of the one or more securities, and wherein the method further comprises: sending, to a distributed ledger, a request to record the token and ownership of the token on the distributed ledger.

5. The computerized method of claim 4, further comprising: communicating, to the distributed ledger for recordation, the transaction to transfer the token to the second addressed account associated with the bidder.

6. The computerized method of claim 1, further comprising: before generating the token, receiving confirmation from a distributed ledger, that the one or more securities is associated with the first addressed account.

7. The computerized method of claim 1, further comprising:
communicating a final auction price to the alternative trading system; and
authorizing a resale of the token in a secondary market.

8. The computerized method of claim 1, wherein the one or more securities comprises at least two different securities to be used to create one or more shares of an exchange traded fund.

9. A non-transitory computer-readable storage medium comprising a set of instructions that, when executed by one or more processors, cause a machine to:
receive inventory of one or more securities available for pre-borrowing;
authorize placement of a right to pre-borrow the one or more securities at an auction administered by an alternative trading system;
receive, into a first addressed account associated with a token generator, the one or more securities that have been auctioned to a bidder;
in response to receiving the one or more securities into the first addressed account, generate a token indicating one or more borrowing parameters; and
upon receiving notification from the alternative trading system that the token is matched with a bid, cryptographically sign a transaction to transfer the token to a second addressed account associated with the bidder.

10. The non-transitory computer-readable storage medium of claim 9, wherein the set of instructions that, when executed by the one or more processors, cause the machine to cryptographically sign the transaction to transfer the token further cause the machine to:
electronically sign, with a private key of the first addressed account; and
generate baseline pricing for the right to pre-borrow the one or more securities, wherein the baseline pricing is a price at which bidding can begin.

11. The non-transitory computer-readable storage medium of claim 10, wherein the baseline pricing includes a fee payable to an owner of the one or more securities, wherein the set of instructions that, when executed by the one or more processors, cause the machine to pay the fee to the owner of the one or more securities when the one or more securities have been pre-borrowed.

12. The non-transitory computer-readable storage medium of claim 9, wherein the one or more borrowing parameters includes an identity of the one or more securities auctioned to the bidder, a bid amount to pre-borrow the one or more securities, and an owner or beneficial owner of the one or more securities, and wherein the set of instructions, when executed by the one or more processors, further cause the machine to send, to a distributed ledger, a request to record the token and ownership of the token on the distributed ledger.

13. The non-transitory computer-readable storage medium of claim 12, wherein the set of instructions, when executed by the one or more processors, further cause the machine to communicate, to the distributed ledger, the transaction transferring the token to the second addressed account associated with the bidder.

14. The non-transitory computer-readable storage medium of claim 9, wherein the set of instructions, when executed by the one or more processors, further cause the machine to receive, before generating the token, confirmation from a distributed ledger that the one or more securities is associated with the first addressed account.

15. The non-transitory computer-readable storage medium of claim 9, wherein the set of instructions, when executed by the one or more processors, further cause the machine to:
communicate a final auction price to the alternative trading system; and
authorize a resale of the token in a secondary market.

16. A computerized method comprising:
receiving, at an alternative trading system, an indication of one or more securities available for pre-borrowing through an auction;
holding the auction at the alternative trading system;
matching, by the alternative trading system, the bid with a token identifying the one or more securities, an owner or beneficial owner of the one or more securities, and a bid price for the right to pre-borrow the one or more securities, the token being associated with a first addressed account; and
sending, to a computer system, a request to cryptographically transfer the token into a second addressed account associated with the successful bidder and to record the transfer to a distributed ledger.

17. The computerized method of claim 16, further comprising: prior to matching the bid, receiving confirmation from a distributed ledger that the token is associated with the first addressed account.

18. The computerized method of claim 16, wherein holding the auction at the alternative trading system comprises receiving one or more bids for a right to pre-borrow the one or more securities, and matching a successful bidder with a bid.

19. The computerized method of claim 16, further comprising:
receiving a buy order to purchase the token from a buyer and a sell order to sell the token from the successful bidder;
matching the buy order with the sell order; and
executing a transaction between the buyer and the successful bidder to transfer the token to the buyer, wherein the token is electronically transferred from the successful bidder to the buyer when the successful bidder electronically signs the transaction.

20. The computerized method of claim 16, further comprising: communicating the transaction to a distributed ledger for recordation.

21. The computerized method of claim 16, wherein the one or more securities comprises at least two different securities to be used to create one or more shares of an exchange traded fund.

22. A non-transitory, computer-readable storage medium comprising a set of instructions that, when executed by one or more processors, cause a machine to:
receive, at an alternative trading system, an indication of one or more securities available for pre-borrowing through an auction;
hold an auction at the alternative trading system;
match, by the alternative trading system, the bid with a token identifying the one or more securities, an owner or beneficial owner of the one or more securities, and a bid price for the right to pre-borrow the one or more securities, the token being associated with a first addressed account;
send, to a computer system, a request to cryptographically transfer the token into a second addressed account associated with the successful bidder and to record the transfer to a distributed ledger;
receive a buy order to purchase the token from a buyer and a sell order to sell the token from the successful bidder;
match the buy order with the sell order; and
execute a transaction between the buyer and the successful bidder to transfer the token to the buyer, wherein the token is electronically transferred from the successful bidder to the buyer when the successful bidder electronically signs the transaction.

23. A non-transitory computer-readable storage medium comprising a set of instructions that, when executed by one or more processors, cause a machine to:
receive a request to create shares of exchange traded fund, the exchange traded fund comprising at least two different types of securities;
authorize placement of a right to pre-borrow the at least two different types of securities an at an auction administered by an alternative trading system;
receive, into a first addressed account associated with a token generator, the one or more securities that have been auctioned to a bidder;
in response to receiving the one or more securities into the first addressed account, generate a token indicating one or more borrowing parameters; and
upon receiving notification from the alternative trading system that the token is matched with a bid, cryptographically sign a transaction to transfer the token to a second addressed account associated with the bidder.
